(19) United States
(12) Patent Application Publication
(10) Pub. No.: US 2019/0342350 A1
(43) Pub. Date: Nov. 7, 2019

(54) MULTIPLE-RECIPIENT OPTIONS REQUEST IN SESSION INITIATED PROTOCOL (SIP)

(71) Applicant: MAVENIR SYSTEMS, INC., Richardson, TX (US)

(72) Inventors: Zehavit ALON, Raanana (IL); Michael FORTINSKY, Raanana (IL)

(21) Appl. No.: 15/970,334

(22) Filed: May 3, 2018

(51) Int. Cl. H04L 29/06

(52) U.S. Cl. CPC H04L 65/1069; H04L 65/1059; H04L 65/1006; H04L 65/403

(57) ABSTRACT

A user device transmits to a server, a SIP OPTIONS request that includes a list of two or more recipients. The server, in turn, sends a SIP OPTIONS request to each of the recipients, receives a response from each of the recipients, and sends an aggregated response to the user device. The user device thereafter participates in a multiparty communications session with the recipients.

### BACKGROUND OF THE DISCLOSURE

### 1. Field of the Disclosure

The present disclosure relates to a multiparty communications session conducted in accordance with Session Initiation Protocol (SIP).

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

SIP is a communications protocol for signaling, for the purpose of controlling multimedia communication sessions. Common applications of SIP are in Internet telephony for voice and video calls, private Internet Protocol (IP) telephone systems, as well as instant messaging over IP networks. In a communications system, for a subscriber of a communications service to participate in a multiparty communications session in accordance with SIP, the subscriber's user equipment, i.e., a client, must generate a SIP OPTIONS request for each contact about which the equipment needs to obtain information. For example, the first time a client application is activated, one OPTIONS request is sent from the client to each contact in a contact list, and the number of SIP OPTIONS sent by the client is as large as the size of the contact list. Similarly, to enter a chat window, the number of SIP OPTIONS sent by the client is the number of the participants in the Group Chat. In an environment in which bandwidth is limited, such as a wireless network, sending a dedicated request to each contact is problematic.

A Request for Comments (RFC) is a type of publication from the Internet Engineering Task Force (IETF) and the Internet Society (ISOC), the principal technical development and standards-setting bodies for the Internet.

RFC5365 (Multiple-Recipient MESSAGE Requests in the Session Initiation Protocol (SIP)) extends the SIP MESSAGE to multiple recipients.

RFC4662 (A Session Initiation Protocol (SIP) Event Notification Extension for Resource Lists) extends the SIP SUBSCRIBE to multiple resources and RFC5367 (Subscriptions to Request-Contained Resource Lists in the Session Initiation Protocol (SIP)).

However, none of these RFCs discloses an optimization of a SIP OPTIONS request, and there is a need for a system that does not require an originating subscriber to send a dedicated request to each contact in a multiparty communications session.

### SUMMARY OF THE DISCLOSURE

It is an object of the present disclosure to provide a system that operates in accordance with SIP but does not require an originating subscriber to send a dedicated request to each contact in a multiparty communications session. To achieve this object a user device transmits to a server, a SIP OPTIONS request that includes a list of two or more recipients. The server, in turn, sends a SIP OPTIONS request to each of the recipients, receives a response from each of the recipients, and sends an aggregated response to the user device. The user device thereafter participates in a multiparty communications session with the recipients.

There is provided a method that includes performing, by a processor that is a component of a server, operations of (a) receiving from a first user device, a SIP request that includes a list that identifies a second user device, and a third user device, (b) transmitting a SIP request to the second user device, and a SIP request to the third user device, (c) receiving a SIP response from the second user device, and a SIP response from the third user device, (d) preparing an aggregated response that includes capabilities of the second user device and capabilities of the third user device, and (e) sending to the first user device, a SIP response that includes the aggregated response.

There is also provided a method that includes performing, by a processor that is a component of a first user device, operations of (a) receiving from a user interface, a request for a multiparty communications session between the first user device, a second user device and a third user device, (b) preparing a list that identifies the second user device and the third user device, (c) transmitting to a server, a SIP request that includes the list, and (d) receiving from the server, a SIP response that includes capabilities of the second user device and capabilities of the third user device. The first user device thereafter participates in the multiparty communications session in accordance with the capabilities.

### BRIEF DESCRIPTION OF THE DRAWINGS

FIG. 1 is a block diagram of a system that utilizes a multi-recipient OPTIONS request in SIP.

FIG. 2 is a block diagram of several components of the system FIG. 1 engaged in a communications session.

FIG. 3 is a block diagram of program module, and shows some internal operations that are performed between components of the program module 140 during a communications session.

FIG. 4 is a signal flow diagram of operations performed by components of the system of FIG. 1 during communications session.

FIG. 5 is an example of a resource list.

FIG. 6 is an example of a SIP OPTIONS response with SIP fragments (sipfrags).

FIG. 7 is an example of an OPTIONS request.

FIG. 8 is an example of an OPTIONS response.

A component or a feature that is common to more than one drawing is indicated with the same reference number in each of the drawings.

### DESCRIPTION OF THE DISCLOSURE

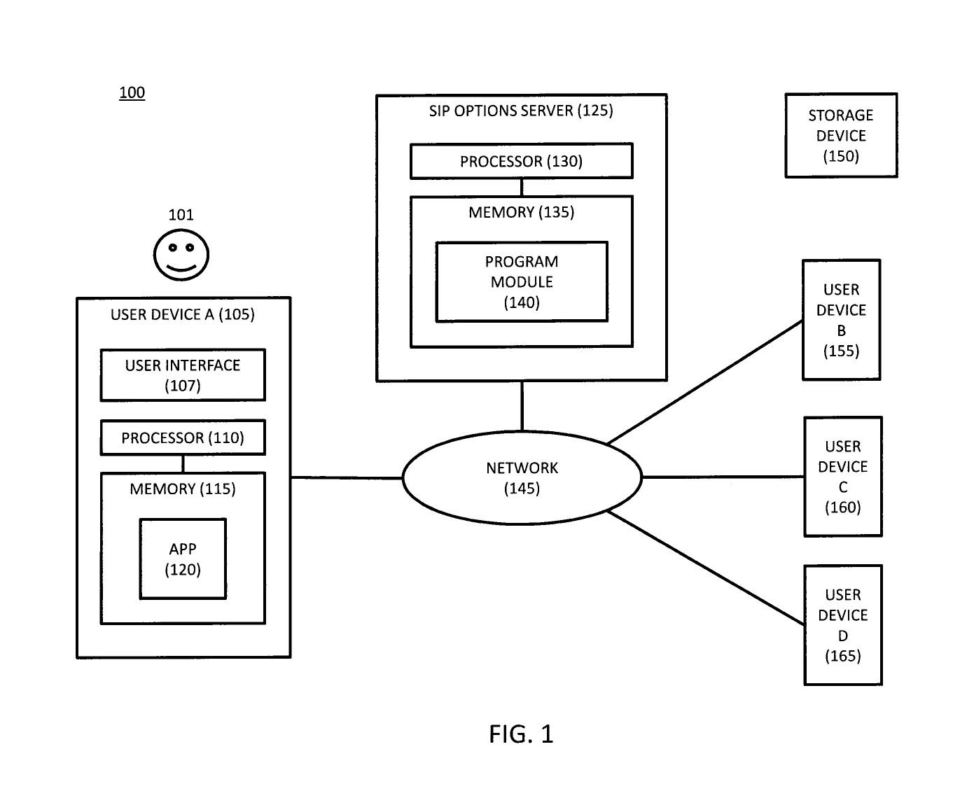

FIG. 1 is a block diagram of a system, namely system 100, that utilizes a multi-recipient OPTIONS request in SIP. System 100 includes a SIP options server 125, a user device A 105, a user device B 155, a user device C 160, and a user device D 165, all of which are communicatively coupled via a network 145. In FIG. 1, components of system 100 are not drawn to scale, but are being shown to represent their functional capabilities.

Network 145 is a data communications network. Network 145 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (0 the Internet, or (g) a telephone network. Communications are conducted via network 145 by way of electronic signals and optical signals that propagate through a wire or optical fiber, or are transmitted and received wirelessly.

SIP options server 125 includes a processor 130, and a memory 135 operationally coupled to processor 130. Although SIP options server 125 is represented herein as a standalone device, it is not limited to such, but instead can be coupled to other devices (not shown) in a distributed processing system.

Processor 130 is an electronic device configured of logic circuitry that responds to and executes instructions.

Memory 135 is a tangible, non-transitory, computer-readable storage device encoded with a computer program. In this regard, memory 135 stores data and instructions, i.e., program code, that are readable and executable by processor 130 for controlling the operation of processor 130. Memory 135 may be implemented in a random access memory (RAM), a hard drive, a read only memory (ROM), or a combination thereof. One of the components of memory 135 is a program module 140.

Program module 140 contains instructions for causing processor 130 to execute operations described herein. In the present document, although we describe operations being performed by SIP options server 125, or by program module 140 or its subordinate processes, the operations are actually being performed by, or in cooperation with, processor 140.

The term “module” is used herein to denote a functional operation that may be embodied either as a stand-alone component or as an integrated configuration of a plurality of subordinate components. Thus, program module 140 may be implemented as a single module or as a plurality of modules that operate in cooperation with one another. Moreover, although program module 140 is described herein as being installed in memory 135, and therefore being implemented in software, it could be implemented in any of hardware (e.g., electronic circuitry), firmware, software, or a combination thereof.

User device A 105 is a communication device, such as a cell phone, and includes a user interface 107, a processor 110 and a memory 115.

Processor 110 is an electronic device configured of logic circuitry that responds to and executes instructions.

Memory 115 is a tangible, non-transitory, computer-readable storage device encoded with a computer program. In this regard, memory 115 stores data and instructions, i.e., program code, that are readable and executable by processor 110 for controlling the operation of processor 110. Memory 115 may be implemented in a random access memory (RAM), a hard drive, a read only memory (ROM), or a combination thereof. One of the components of memory 115 is an application (app) 120.

App 120 is a program module that contains instructions for causing processor 110 to execute operations described herein. In the present document, although we describe operations being performed by user device A 105, or by app 120, the operations are actually being performed by, or in cooperation with, processor 110.

App 120 may be implemented as a single module or as a plurality of modules that operate in cooperation with one another. Moreover, although app 120 is described herein as being installed in memory 115, and therefore being implemented in software, it could be implemented in any of hardware (e.g., electronic circuitry), firmware, software, or a combination thereof.

User interface 107 includes an input device, such as a keyboard, a cursor control, a touch-sensitive screen, a speech recognition subsystem, or a gesture recognition subsystem, for enabling a user 101 to communicate information and command selections to processor 110. User interface 107 also includes an output device such as a display or a speech synthesizer and a speaker.

Each of user device B 155, user device C 160, and user device D 165 is also a communication device, similar to user device A 105.

While program module 140 is indicated as being already loaded into memory 135, and app 120 is indicated as being already loaded into memory 115, either or both of program module 140 and app 120 may be configured on a storage device 150 for subsequent loading into memory 135 and memory 115, respectively. Storage device 150 is a tangible, non-transitory, computer-readable storage device. Examples of storage device 150 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to SIP options server 125 and user device A 105 via network 145.

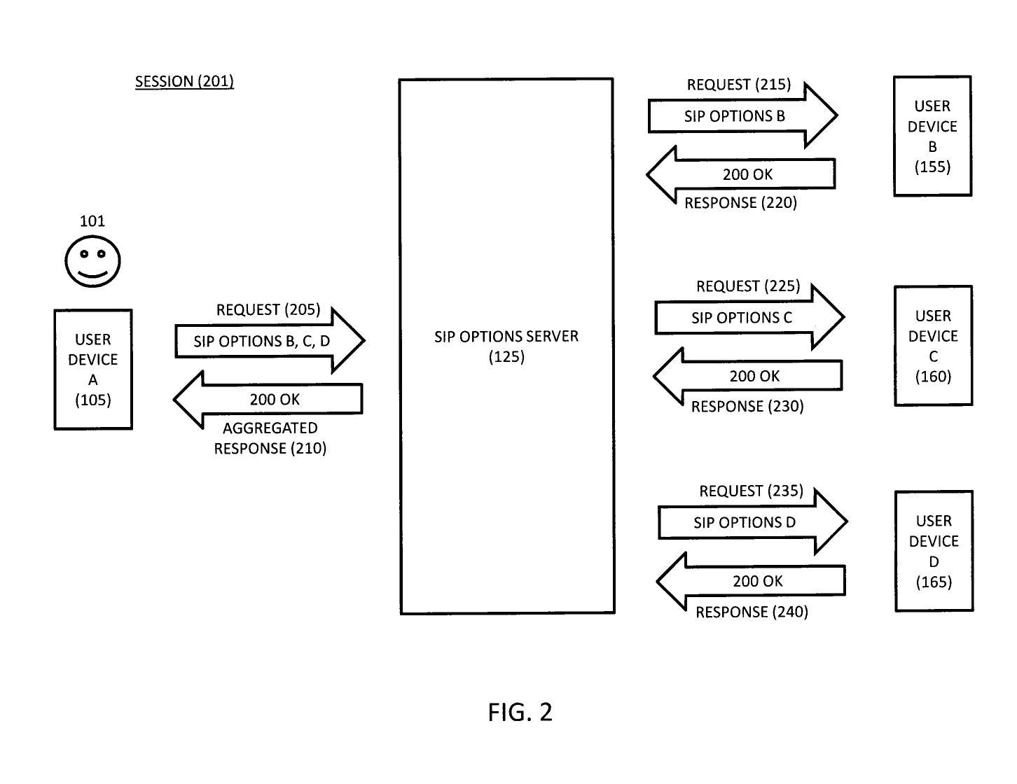

FIG. 2 is a block diagram of several components of system 100 engaged in a communications session, namely session 201. In session 201, user 101 wishes to conduct a multiparty communications session, e.g., a multiparty chat session, with users (not shown) of user device B 155, user device C 160, and user device D 165. Accordingly, user 101, by way of user interface 105, inputs a command or a request for the multiparty communications session.

User device A 105 transmits a request 205 to SIP options server 125. Request 205 includes SIP OPTIONS B, C and D, which includes a list of recipients that identifies user device B 155, user device C 160, and user device D 165.

SIP options server 125 receives request 205, and (a) transmits a request 215 to user device B 155, (b) transmits a request 225 to user device C 160, and (c) transmits a request 235 to user device D 165. Request 215 includes SIP OPTIONS B. Request 225 includes SIP OPTIONS C. Request 235 includes SIP OPTIONS D.

User device B 155 receives request 215, and transmits a response 220, which includes a 200 OK message.

User device C 160 receives request 225, and transmits a response 230, which includes a 200 OK message.

User device D 165 receives request 235, and transmits a response 240, which includes a 200 OK message.

SIP options server 125 receives responses 220, 230 and 240, and prepares and transmits an aggregated response 210, which includes a 200 OK message.

User device A 105 receives aggregated response 210, locally stores/updates a device status and capabilities for each of user device B 155, user device C 160, and user device D 165, and thereafter participates in the multiparty communications session with user device B 155, user device C 160, and user device D 165.

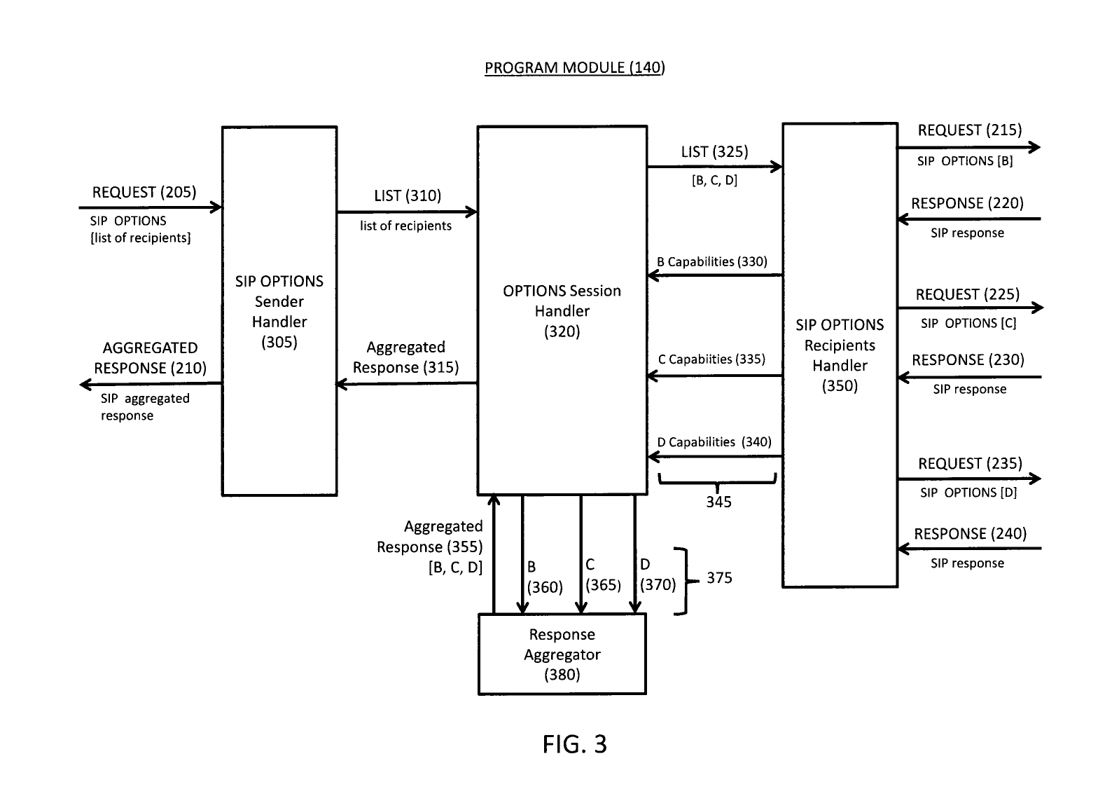

FIG. 3 is a block diagram of program module 140, and shows some internal operations that are performed between components of program module 140 during session 201. Program module 140 includes a SIP OPTIONS sender handler 305, an OPTIONS session handler 320, a SIP options recipient handler 350, and a response aggregator 380.

SIP OPTIONS sender handler 305 (a) receives request 205, which includes the list of recipients, (b) extracts the list of recipients, and (c) sends the list of recipients in a list 310 to OPTIONS session handler 320.

Options session handler 320 receives list 310, and sends the list of recipients in a list 325 to SIP OPTIONS recipient handler 350.

SIP OPTIONS recipients handler 350 (a) receives list 325, (b) transmits requests 215, 225 and 235, and (c) receives responses 220, 230 and 240. Thereafter, SIP OPTIONS recipient handler 350 prepares B capabilities 330, C capabilities 335, and D capabilities 340. B capabilities 330 are capabilities of user device B 155. C capabilities 335 are capabilities of user device C 160. D capabilities 340 are capabilities of user device D 165. When a device receives a request of SIP options, the device may add feature parameters to a Contact header field in the OPTIONS response for the purpose of indicating the capabilities of the device. To do that, it constructs a set of feature parameters that are then added as Contact header field parameters in OPTIONS response. B capabilities 330, C capabilities 335, and D capabilities 340 are collectively referred to as capabilities 345.

OPTIONS session handler 320 receives capabilities 345, and passes them to response aggregator 380 as B capabilities 360, C capabilities 365, and D capabilities 370, which are collectively referred to as capabilities 375.

Response aggregator 380, receives capabilities 375, and prepares an aggregated response 355. More specifically, response aggregator 380 has an interface with OPTIONS session handler 320 for handling all responses and their status including control monitoring.

Response aggregator 380 receives users' devices capabilities responses, updates the responses, and stores the information in memory up to completion of all pending requests replies.

SIP OPTIONS sender handler 305 receives aggregated response 315, and passes it on as aggregated response 210. Aggregated response 210 contains the set of features, capabilities and network registration status for each of user device B 155, user device C 160, and user device D 165. Device registration status determines the device status whether online or offline, a device sends periodically (every one hour by default), SIP REGISTER message to the core network, this information is being distributed by the core network S-CSCF to any registered application using 3rd part Sip REGISTER, this information is being stored, messaging and calls to a specific device are applied based on this device status.

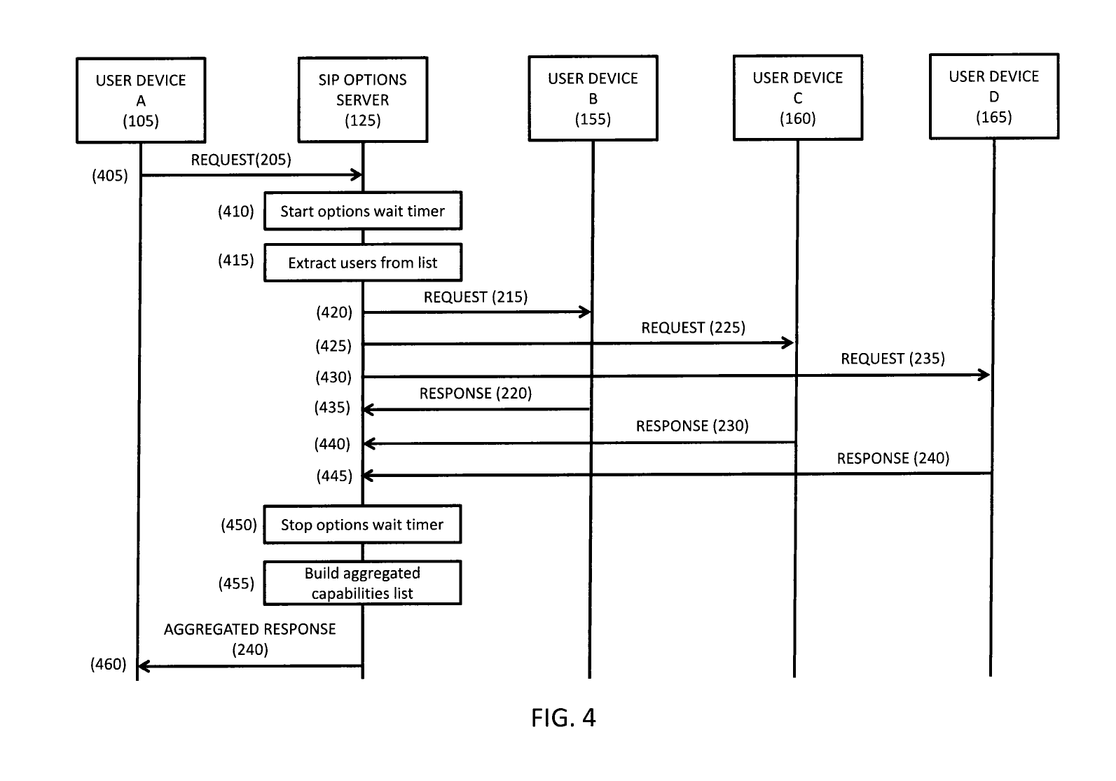

FIG. 4 is a signal flow diagram of operations performed by components of system 100 during session 201. Recall that in session 201, user 101 wishes to conduct a multiparty communications session with users of user device B 155, user device C 160, and user device D 165, and accordingly, by way of user interface 105, inputs a command or a request for the multiparty communications session.

In operation 405, user device A 105 transmits, and SIP options server 125 receives, request 205.

In operation 410, SIP options server 125 starts an options wait timer. The option wait timer is a control function that guarantees proper handling of communication between SIP options server 125 and user device B 155, user device C 160, and user device D 165, and terminates the communication in a case of a network/application error.

In operation 415, SIP options server 125 extracts the list of recipients from request 205.

In operation 420, SIP options server 125 transmits, and user device B 155 receives, request 215.

In operation 425, SIP options server 125 transmits, and user device C 160 receives, request 225.

In operation 430, SIP options server 125 transmits, and user device D 165 receives, request 235.

In operation 435, user device B 155 transmits, and SIP options server 125 receives, response 220.

In operation 440, user device C 160 transmits, and SIP options server 125 receives, response 230.

In operation 445, user device D 165 transmits, and SIP options server 125 receives, response 240.

In operation 450, SIP options server 125 stops the options wait timer.

In operation 455, SIP options server 125 builds the aggregated capabilities list.

In operation 460, SIP options server 125 transmits, and user device A receives aggregated response 240. User device A 105 thereafter participates in the multiparty communications session with user device B 155, user device C 160, and user device D 165 in accordance with the capabilities in the aggregated capabilities list.

Operations 420, 425, 430, 435, 440 and 445 need not be performed in the order that is shown in FIG. 4, and in practice, may not occur in the order that is shown in FIG. 4. For example, in practice, user device D 165 might generate response 240 before user device B 155 generates response 220, and as such, operation 445 may occur before operation 435.

In practice, system 100 can facilitate a multiparty communications session between user device A 105 and any number of two or more other user devices. Thus, in an example, user device A 105, and more specifically processor 110, performs a method that includes (a) receiving from user interface 107, a request for a multiparty communications session between user device A 105, user device B 155, and user device C 160, (b) preparing a list that identifies user device B 155 and user device C 160, (c) transmitting to SIP options server 125, a SIP request, i.e., request 205, that includes the list, and (d) receiving from SIP options server 125, a SIP response, i.e., aggregated response 210, that includes capabilities of user device B 155 and capabilities of user device C 160. User device A 105 thereafter participates in the multiparty communications session in accordance with the capabilities.

Likewise, in this example, SIP options server 125, and more specifically processor 130, performs operations of (a) receiving from user device A 105, the SIP request, i.e., request 205, that includes the list that identifies user device B 155, and user device C 160, (b) transmitting request 215 to user device B 155, and request 225 to user device C 160, (c) receiving response 220 from user device B 155, and response 230 from user device C 160, (d) preparing aggregated response 210, which includes capabilities of user device B 155 and capabilities of user device C 160, and (e) sending to user device A 105, aggregated response 210.

System 100 allows a SIP User Agent Client (UAC) to send a SIP OPTIONS request to a set of destinations, by using (1) a SIP URI-list (Uniform Resource Identifier list) service, and (2) a list body part.

A resource list is identified by a URI, and it represents a list of zero or more URIs. Each of these URIs is an identifier for an individual user for which the subscriber wants to receive information. In many cases, the URI used to identify the resource list will be a SIP URI. The resource list may be specified by an XML file as defined in RFC4826 (Extensible Markup Language (XML) Formats for Representing Resource Lists).

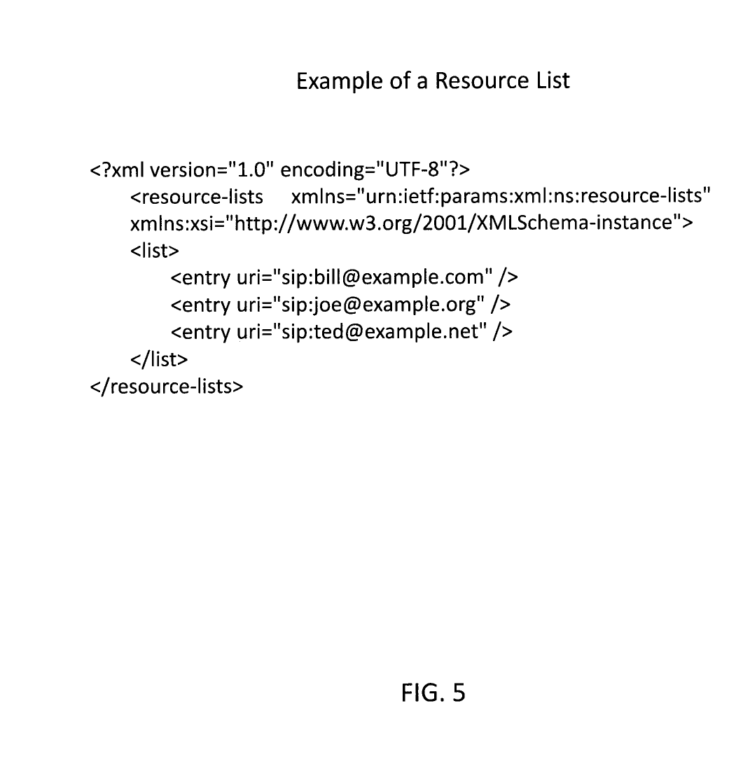

FIG. 5 is an example of a resource list.

The UAC sends one SIP OPTIONS request to the SIP OPTIONS server. The OPTIONS request can contain a list of contacts in the form of a resource list (as described above). When the SIP request contains a list, the SIP OPTIONS server will create and send a separate SIP OPTIONS request for each entry in the list. The server will wait for the response from all the sent requests. It will create a SIP response that will contain the aggregated response in a multipart MIME body. Each body part contains the OPTIONS response or part of the response from a specific contact. The format conforms to the message/SIP fragment (sipfrag) element defined in RFC3420. RFC3420 specifies how part of a SIP message can be sent in the message body of another SIP message.

For Example, assume the following:
(i) A-Party device sends a SIP OPTIONS request where it asked for the capabilities related to 2 users.
(ii) OPTIONS request arrives at the application server (AS)
(iii) AS sends 1 OPTIONS request to user1 and 1 OPTIONS request to user2.
(iv) AS collects the responses and builds a single response to send back to the A-Party device. The response contains, within the message body, the actual responses of user1 and user2 (but only the important information from the responses). Therefore, each body part is a partial SIP OPTIONS response, which is called a sipfrag.

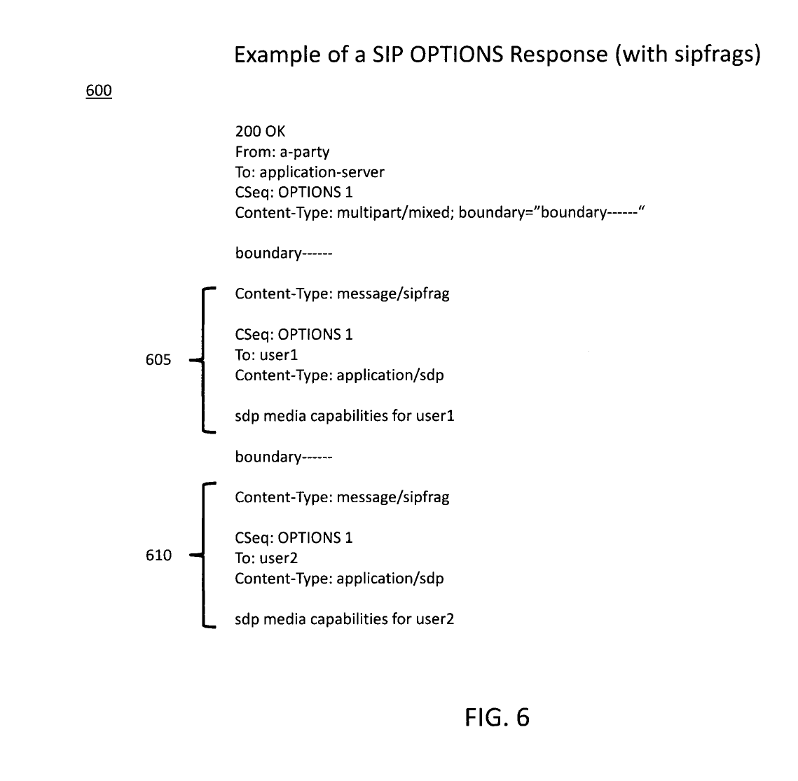

FIG. 6 is an example 600, of a SIP OPTIONS response with sipfrags. Example 600 includes a sipfrag 605 that contains user1 information, and a sipfrag 610 that contains user2 information. Example 600 is pseudo-code to illustrate functionality, not complete or accurate syntax.

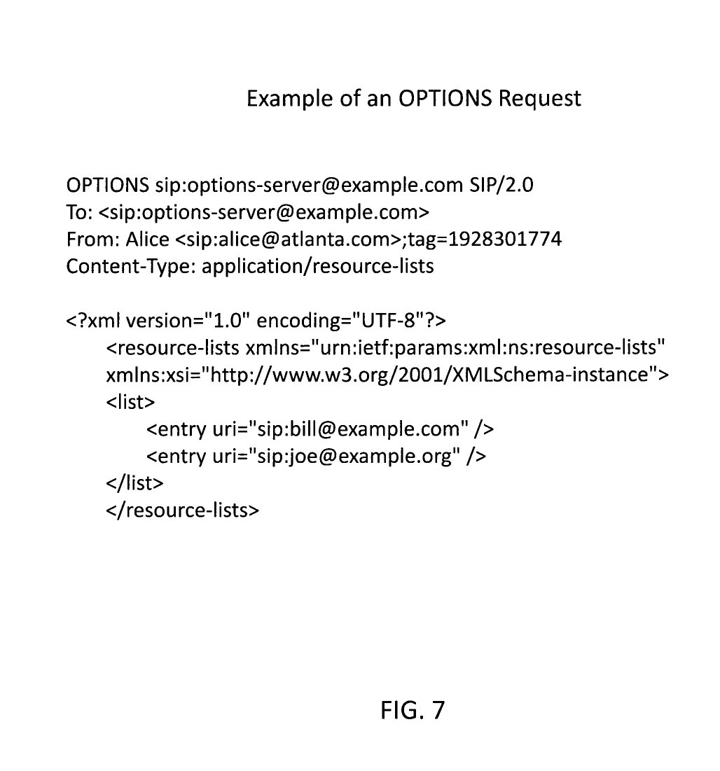

FIG. 7 is an example of an OPTIONS request. For clarity, headers unrelated to the features described herein are not shown.

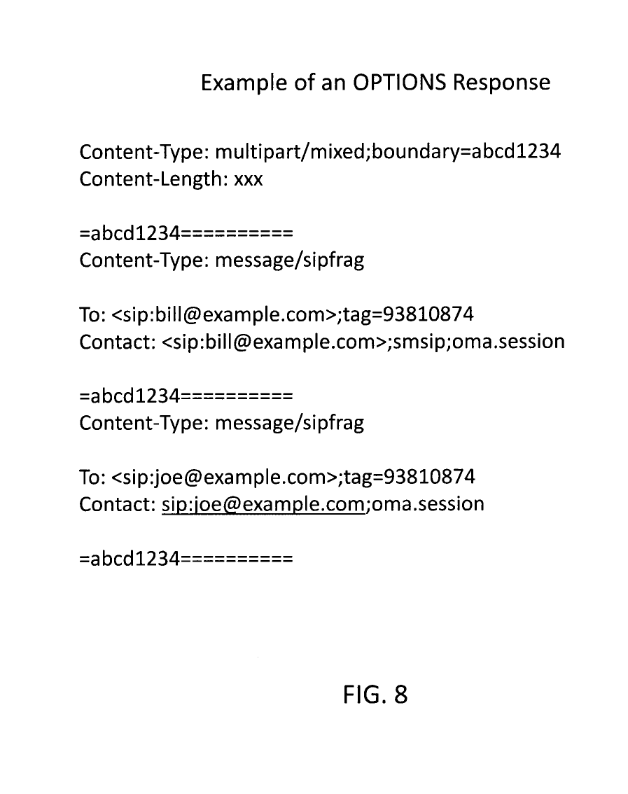

FIG. 8 is an example of an OPTIONS response. For clarity, headers unrelated to the features described herein are not shown.

A technical benefit of system 100 is that it may significantly reduce the signaling traffic related to SIP OPTIONS, and thus save network bandwidth on the originating side of the multiparty communications session, e.g., on the side of user device A 105. System 100 may also save resources, and increase speed of device operations. System 100 saves resources on network 145 and device 105 where this operation is performed at once for all users' lists. It provides one tie authentication, single request from device 105 and an aggregated response that can be compressed. Device 105 stores this information at once, uses this information locally for any incoming/outgoing message or a call, and thus saves device resources such as battery, central processor (CPU) and memory, and saves network data utilization.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
performing, by a processor that is a component of a server, operations of:
receiving from a first user device, a Session Initiation Protocol (SIP) request that includes a list that identifies a second user device, and a third user device;
transmitting a SIP request to said second user device, and a SIP request to said third user device;
receiving a SIP response from said second user device, and a SIP response from said third user device;
preparing an aggregated response that includes capabilities of said second user device and capabilities of said third user device; and
sending to said first user device, a SIP response that includes said aggregated response.

2. The method of claim 1,
wherein said processor is a first processor, and
wherein said method further comprises:
performing, by a second processor that is a component of said first user device, operations of:
receiving from a user interface, a request for a multiparty communications session between said first user device, said second user device, and said third user device;
preparing said list in response to said request for said multiparty communications session; and
transmitting to said first processor, said SIP request that includes said list.

3. The method of claim 2, further comprising, said second processor performing an additional operation of:
receiving said SIP response that includes said aggregated response,
wherein said first user device thereafter participates in said multiparty communications session in accordance with said capabilities.

4. A method comprising:
performing, by a processor that is a component of a first user device, operations of:
receiving from a user interface, a request for a multiparty communications session between said first user device, a second user device and a third user device;
preparing a list that identifies said second user device and said third user device;
transmitting to a server, a Session Initiation Protocol (SIP) request that includes said list; and
receiving from said server, a SIP response that includes capabilities of said second user device and capabilities of said third user device;
wherein said first user device thereafter participates in said multiparty communications session in accordance with said capabilities.

5. A system comprising a server having:
a processor; and
a memory that contains instructions that are readable by said processor to cause said processor to perform operations of:
receiving from a first user device, a Session Initiation Protocol (SIP) request that includes a list that identifies a second user device, and a third user device;
transmitting a SIP request to said second user device, and a SIP request to said third user device;
receiving a SIP response from said second user device, and a SIP response from said third user device;
preparing an aggregated response that includes capabilities of said second user device and capabilities of said third user device; and
sending to said first user device, a SIP response that includes said aggregated response.

6. The system of claim 5,
wherein said processor is a first processor, said memory is a first memory, and said instructions are first instructions, and
wherein said first user device comprises:
a user interface;
a second processor; and
a second memory that contains second instructions that are readable by said second processor to cause said second processor to perform operations of:
receiving from said user interface, a request for a multiparty communications session between said first user device, said second user device, and said third user device;
preparing said list in response to said request for said multiparty communications session; and
transmitting to said first processor, said SIP request that includes said list.

7. The system of claim 6, wherein said second instructions also cause said second processor perform an operation of:
receiving said SIP response that includes said aggregated response,
wherein said first user device thereafter participates in said multiparty communications session in accordance with said capabilities.

8. A first user device comprising:
a user interface;
a processor; and
a memory that contains instructions that are readable by said processor to cause said processor to perform operations of:
receiving from said user interface, a request for a multiparty communications session between said first user device, a second user device and a third user device;
preparing a list that identifies said second user device and said third user device;
transmitting to a server, a Session Initiation Protocol (SIP) request that includes said list; and
receiving from said server, a SIP response that includes capabilities of said second user device and capabilities of said third user device,
wherein said first user device thereafter participates in said multiparty communications session in accordance with said capabilities.

9. A storage device that contains instructions that are readable by a processor that is a component of a server, to cause said processor to perform operations of:
receiving from a first user device, a Session Initiation Protocol (SIP) request that includes a list that identifies a second user device, and a third user device;
transmitting a SIP request to said second user device, and a SIP request to said third user device;
receiving a SIP response from said second user device, and a SIP response from said third user device;
preparing an aggregated response that includes capabilities of said second user device and capabilities of said third user device; and
sending to said first user device, a SIP response that includes said aggregated response.

10. A storage device that contains instructions that are readable by a processor that is a component of a first user device, to cause said processor to perform operations of:
receiving from a user interface, a request for a multiparty communications session between said first user device, a second user device and a third user device;
preparing a list that identifies said second user device and said third user device;
transmitting to a server, a Session Initiation Protocol (SIP) request that includes said list; and
receiving from said server, a SIP response that includes capabilities of said second user device and capabilities of said third user device;
wherein said first user device thereafter participates in said multiparty communications session in accordance with said capabilities.
